(19) United States
(12) Patent Application Publication
(10) Pub. No.: US 2015/0295422 A1
(43) Pub. Date: Oct. 15, 2015

(54) VEHICLE EMERGENCY RESCUE DEVICE

(71) Applicant: C-TECH UNITED CORP., New Taipei City (TW)

(72) Inventor: Shao Kang CHEN, New Taipei City (TW)

(73) Assignee: C-TECH UNITED CORP., New Taipei City (TW)

(21) Appl. No.: 14/253,679

(22) Filed: Apr. 15, 2014

(51) Int. Cl. H02J 7/00

(52) U.S. Cl. CPC H02J 7/007; H02J 7/0054

(57) ABSTRACT

A vehicle emergency rescue device includes a control unit, a charging and discharging circuit, a battery set, an output voltage converter, a computing unit, a connection terminal and a display device. Subject to the functioning of the inner computing unit and the outer display device, the user can know the car battery capacity and status, the charging time required and the time remaining for full battery charge during the operation of the vehicle emergency rescue device to charge the car battery of the vehicle.

### BACKGROUND OF THE INVENTION

1. Field of the Invention

The present invention relates to vehicle battery charging technology and more particularly, to a vehicle emergency rescue device that is capable of automatically charging the battery of the vehicle in an emergency situation and has a display device for displaying charging related data.

2. Description of the Related Art

If a car cannot be started due to battery low or aged battery, the car battery must be quickly charged with an external power source.

When charging the car battery, the user needs to open the engine compartment lid, and then disconnect the battery wires, and then fasten battery clamps of a jumper cable to the positive and negative terminals of the car battery to charge the car battery with an external power source. Due to the constraint of current limit, this car battery charging operation must be performed by a technician or skilled person. In order to let ordinary people charge the car battery, specific voltage car battery chargers are created. However, before charging the car battery with a specific voltage car battery charger, the user of the specific voltage car battery charger still needs to open the engine compartment lid and then fasten the battery clamps of the specific voltage car battery charger to the positive and negative terminals of the car battery. This car battery charging procedure is somewhat dangerous to female drivers, and still has its inconveniences.

In order to overcome the aforesaid problem, vehicle emergency rescue devices for charging the car battery of a vehicle in an emergency situation are created. FIG. 1 illustrates a similar prior art design. A vehicle emergency rescue device of this type can be directly connected to the car cigarette lighter to charge the car battery, bringing convenience to people, more particularly, to female drivers. However, due to the consideration of compact size, conventional vehicle emergency rescue devices simply provide a charging function without providing any charging related data. In case of charging failure due to failure of the vehicle emergency rescue device, the user cannot immediately know the condition, leading to time-wasting, anxiety or anger.

### SUMMARY OF THE INVENTION

The present invention has been accomplished under the circumstances in view. It is the main object of the present invention to provide a vehicle emergency rescue device, which enables the user to know the car battery capacity and status, the charging time required and the time remaining for full battery charge during the operation of the vehicle emergency rescue device to charge the car battery of the vehicle.

To achieve this and other objects of the present invention, a vehicle emergency rescue device for use in a vehicle in accordance with the present invention comprises a control unit, a charging and discharging circuit electrically coupled to the control unit, a battery set electrically coupled to the charging and discharging circuit and controllable by the charging and discharging circuit subject to the control of the control unit to be charged by an external power source or to discharge electricity, an output voltage converter electrically coupled to the battery set for receiving discharged battery power supply from the battery set and converting the battery power supply into one of a series of voltage levels for output, a computing unit electrically coupled to the output voltage converter and the control unit for receiving the converted battery power supply outputted by the output voltage converter and measuring the current, voltage, temperature and time size of the converted battery power supply passing therethrough and providing the measured voltage, current and temperature values to the control unit, a connection terminal electrically coupled to the computing unit and electrically connectable to the car cigarette lighter of the vehicle carrying the vehicle emergency rescue device for charging the car battery of the vehicle with the converted batter power supply provided by the output voltage converter, and a display device electrically coupled to the control unit and controllable by the control unit to display charging related data.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 illustrates a vehicle emergency rescue device according to the prior art.

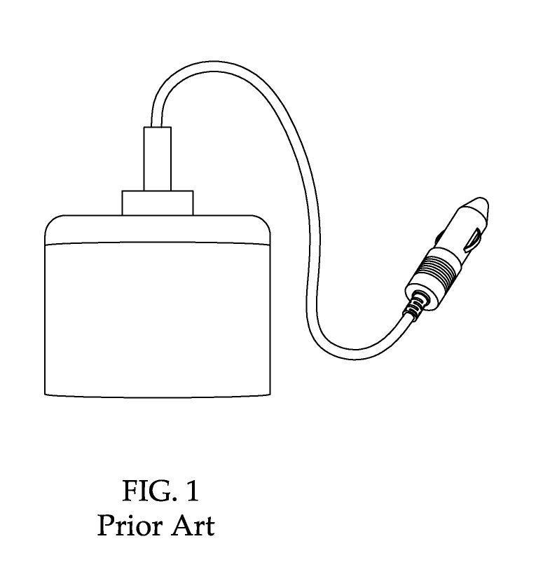

FIG. 2 is a system block diagram of a vehicle emergency rescue device in accordance with the present invention.

FIG. 3 is an elevational view of the vehicle emergency rescue device in accordance with the present invention.

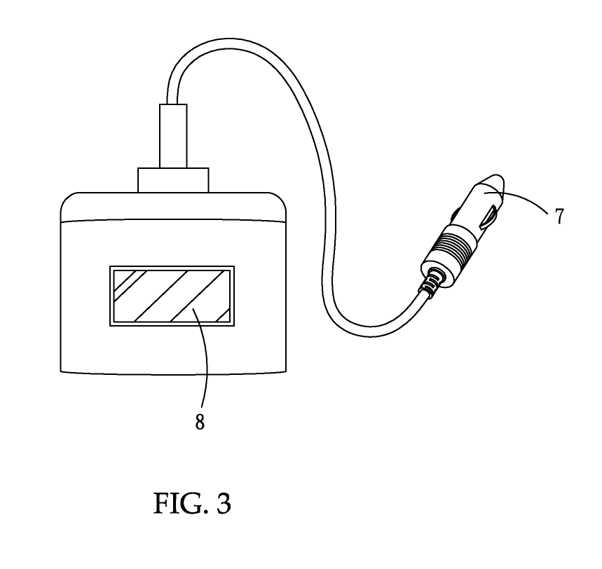

### DETAILED DESCRIPTION OF THE PREFERRED EMBODIMENT

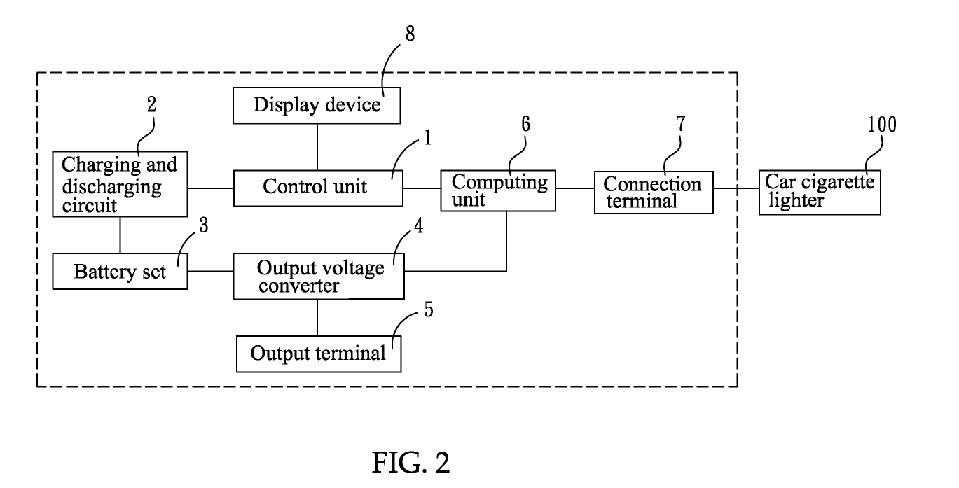

Referring to FIG. 2, a vehicle emergency rescue device in accordance with the present invention is shown. The vehicle emergency rescue device comprises a control unit 1 that is the control center of the vehicle emergency rescue device for controlling the operations of all component parts of the vehicle emergency rescue, a charging and discharging circuit 2 electrically coupled to the control unit 1, a battery set 3, for example, but not limited to, lithium battery set electrically coupled to the charging and discharging circuit 2 and controllable by the charging and discharging circuit 2 subject to the control of the control unit 1 to be charged by an external power source or to discharge electricity, an output voltage converter 4 electrically coupled to the battery set 3 for receiving discharged battery power supply from the battery set 3 and converting it into one of a series of voltage levels for output, an output terminal 5, for example, but not limited to, USB connector electrically coupled to the output voltage converter 4 for power output, a computing unit 6 prepared from a coulomb meter, voltage sensor device, current sensor device or temperature sensor device, or one of their combinations, and electrically coupled to the output voltage converter 4 for receiving the converted battery power supply from the output voltage converter 4 and measuring the current, voltage, temperature and time size of the converted battery power supply passing therethrough and also electrically coupled to the control unit 1 to provide the measured voltage, current or temperature value to the control unit 1, a connection terminal 7 electrically coupled to the computing unit 6 and electrically connectable to the car cigarette lighter 100 of the vehicle that carries the vehicle emergency rescue device for charging the car battery of the vehicle with the converted batter power supply outputted by the output voltage converter 4, and a display device 8 electrically coupled to the control unit 1 and controllable by the control unit 1 to display charging related data, enabling the user to know the current charging progress, the charging time required and the time remaining for full battery charge. Further, the display device 8 can be a LCD display device, a LCD display device, or a communication interface.

Subject to the functioning of the inner computing unit 6 and the outer display device 8, the user of the vehicle emergency rescue device can know the car battery capacity and status, the charging time required and the time remaining for full battery charge during the operation of the vehicle emergency rescue device to charge the car battery of the vehicle.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A vehicle emergency rescue device for use in a vehicle, comprising:
a control unit;
a charging and discharging circuit electrically coupled to said control unit;
a battery set electrically coupled to said charging and discharging circuit and controllable by said charging and discharging circuit subject to the control of said control unit to be charged by an external power source or to discharge electricity;
an output voltage converter electrically coupled to said battery set for receiving discharged battery power supply from said battery set and converting said battery power supply into one of a series of voltage levels for output;
a computing unit electrically coupled to said output voltage converter and said control unit for receiving the converted battery power supply outputted by said output voltage converter and measuring the current, voltage, temperature and time size of the converted battery power supply passing therethrough and providing the measured voltage, current and temperature values to said control unit;
a connection terminal electrically coupled to said computing unit and electrically connectable to a car cigarette lighter of a vehicle carrying the vehicle emergency rescue device for charging the car battery of said vehicle with the converted batter power supply provided by said output voltage converter; and
a display device electrically coupled to said control unit and controllable by said control unit to display charging related data.

2. The vehicle emergency rescue device as claimed in claim 1, wherein said battery set is a lithium battery set.

3. The vehicle emergency rescue device as claimed in claim 1, further comprising an output terminal electrically coupled to said output voltage converter for power output.

4. The vehicle emergency rescue device as claimed in claim 3, wherein said output terminal is a USB connector.

5. The vehicle emergency rescue device as claimed in claim 1, wherein said computing unit is a coulomb meter.

6. The vehicle emergency rescue device as claimed in claim 1, wherein said computing unit is selected from the group of voltage sensor device, current sensor device, temperature sensor device, and the combinations thereof.

7. The vehicle emergency rescue device as claimed in claim 1, wherein said display device is a LED display device.

8. The vehicle emergency rescue device as claimed in claim 1, wherein said display device is a LCD display device.

9. The vehicle emergency rescue device as claimed in claim 1, wherein said display device is a communication interface device.
